(19) United States
(12) Patent Application Publication
(10) Pub. No.: US 2006/0136533 A1
(43) Pub. Date: Jun. 22, 2006

(54) Electric apparatus and method for game

(76) Inventor: Yun-Ching Peng, Kaohsiung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/017,908

(22) Filed: Dec. 22, 2004

(51) Int. Cl. G06F 15/00

(52) U.S. Cl. 708/200

(57) ABSTRACT

An electric apparatus for a game includes a display unit, an operational unit, and an input unit. The display unit displays a mathematic expression including a plurality of parameters and corresponding values of the parameters. The operational unit calculates a correct answer of the mathematic expression. The input unit allows at least one player to input selected answer of the mathematic expression. The mathematic expression is displayed on the display unit before input of the selected answer. The correct answer of the mathematic expression is displayed after input of the selected answer. A method for playing a game includes displaying a mathematic expression including a plurality of parameters and values of the parameters on a display unit, inputting selected answer of the mathematic expression by at least one player, and displaying a correct answer of the mathematic expression.

### BACKGROUND OF THE INVENTION

1. Field of the Invention

The present invention relates to an apparatus for a game. In particular, the present invention relates to an electric apparatus for a game. The present invention also relates to a method for a game.

2. Description of the Related Art

An electric apparatus for a game, particularly a gambling game or the like, comprises a plurality of sets of input buttons allowing players to input the wager amount and to select the icons representing numbers, figures, etc to bet on. The wining number or winning combination is often decided by random. Due to rapid operating speed of the central processing units, it is however still doubtful that the electric apparatus plays tricks by the programs, as it is impossible to show the wining number or winning combination in advance.

### SUMMARY OF THE INVENTION

An objective of the present invention is to provide an electric apparatus and a method for a game that displays the wining number or winning combination by a mathematic expression before input of the wager amount, providing a fair game.

In accordance with an aspect of the invention, an electric apparatus for a game comprises a display unit, an operational unit, and an input unit. The display unit displays a mathematic expression including a plurality of parameters and corresponding values of the parameters. The operational unit calculates a correct answer of the mathematic expression. The operational unit includes a memory for storing programs relating to the mathematic expression. The input unit allows at least one player to input selected answer of the mathematic expression. The mathematic expression is displayed on the display unit before input of the selected answer. The correct answer of the mathematic expression is displayed after input of the selected answer.

The input unit comprises at least one set of buttons. The display unit may be a monitor. In an embodiment of the invention, the operational unit is a computer host. The memory is a chip that stores programs and information relating to the mathematic expression.

The electric apparatus may further comprise an output unit for displaying the correct answer of the mathematic expression. Alternatively, the correct answer of the mathematic expression is displayed by the display unit.

Preferably, the operational unit compares the selected answer with the corrected answer. Preferably, the mathematic expression includes at least one mathematic sign.

In accordance with another aspect of the invention, a method for playing a game comprises the steps of:

displaying a mathematic expression including a plurality of parameters and values of the parameters on a display unit;

inputting selected answer of the mathematic expression by at least one player; and

displaying a correct answer of the mathematic expression.

The step of displaying may include displaying a question relating to the mathematic expression. The method may include a step of comparing the selected answer with the correct answer. Preferably, the mathematic expression includes at least one mathematic sign.

Other objectives, advantages, and novel features of the invention will become more apparent from the following detailed description when taken in conjunction with the accompanying drawings.

### BRIEF DESCRIPTION OF THE DRAWINGS

FIG. 1 is a schematic perspective view of an electric apparatus for a game in accordance with the present invention.

FIG. 2 is a schematic flowchart illustrating operation of the electric apparatus in accordance with the present invention.

### DETAILED DESCRIPTION OF THE PREFERRED EMBODIMENT

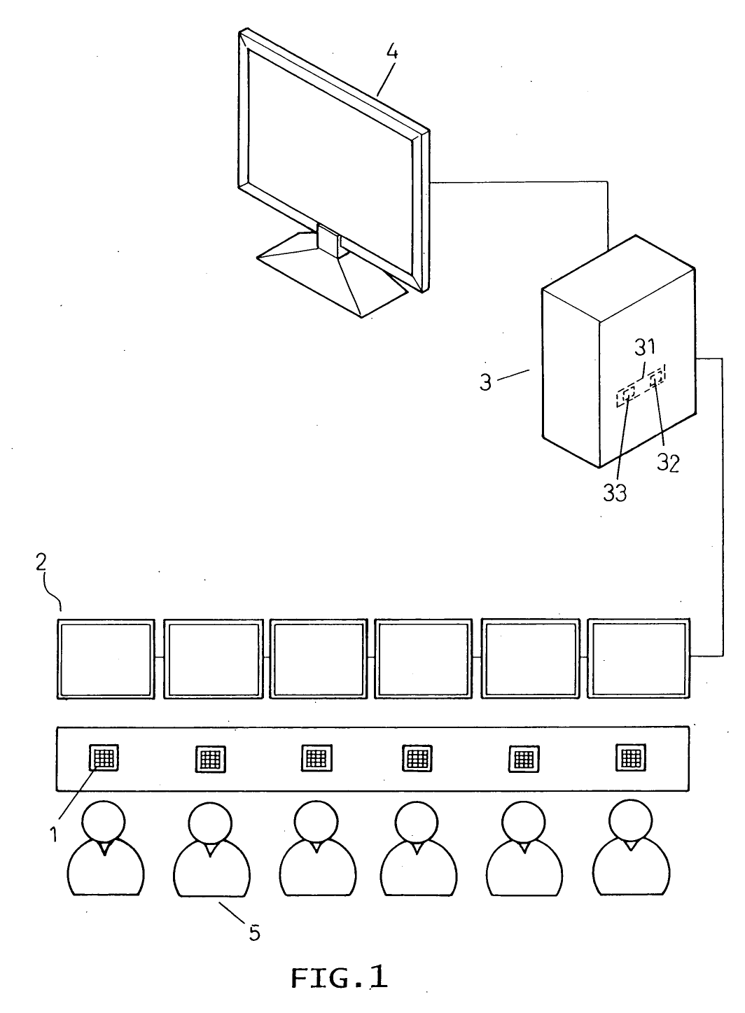

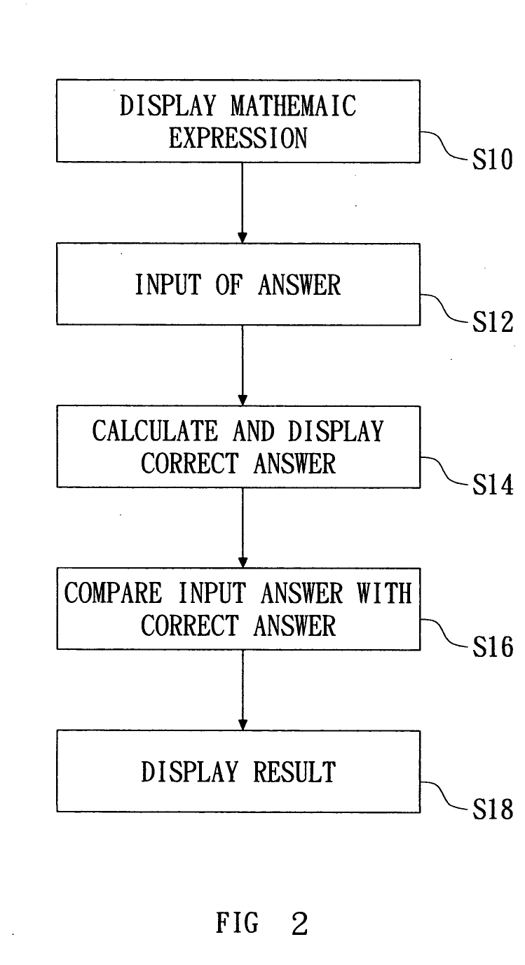

Referring to FIGS. 1 and 2, an electric apparatus for a game in accordance with the present invention comprises an input unit 1, a display unit 2 for displaying input result of the input unit 1, an operational unit 3, and an output unit 4.

The input unit 1 includes at least one set of input buttons, allowing at least one player 5 to input the wager amount and/or the icon(s) to bet on. The icons represent numbers, figures, etc. Alternatively, the icons represent “>” (greater than) and “<” (smaller than). It is noted that any kinds of icons can be used. Input of the player(s) is displayed by the display unit 2 that may be a monitor or the like. Input of the wager amount and/or the icon(s) through the buttons of the input unit 1 is referred to as “wagering procedure”.

The operational unit 3 may be a computer host including a memory 31. The memory 31 may be a chip that stores programs and/or information relating to a mathematic expression that is displayed on the display unit 2. The mathematic expression includes a plurality of parameters and/or mathematic signs (” +”, “−”, “×“, “÷”, etc). The value of each parameter is also displayed. Each parameter is a number, preferably an integer. The operational unit 3 further includes a program 33 for calculating the result of the mathematic expression.

In use, a mathematic expression is displayed on the display unit 2 so that the player(s) can see it (S10). For example, the mathematic expression is as follows:

ABCJICPKEHDKFN@BRIVYCNIRNWNOCURNCRPWE−ADOWER FCJ×5ADOINWQRENOQNDIOFNQMPCPMGF%÷PTJALKSDJFQREWU#+LKJALKSDJLKJAEIVJAISJVIASW&EH

The electric apparatus shows the following information on the display unit 2:

PLEASE CALCULATE THE RESULT OF THE FOLLOWING MATHETIC EXPRESSION:

ABCJICPKEHDKFN@BRIVYCNIRNWNOCURNCRPWE−ADOWER FCJ× 5ADOINWQRENOQNDIOFNQMPCPMGF%÷PTJALKSDJFQREWU#+LKJALKSDJLKJAEIVJAISJVIASW&EH

WHEREIN THE PARAMETERS IN THE MATHETIC EXPRESSION ARE AS FOLLOWS:

1=J 2=C 3=I 4=A 5=B 6=@ 7=D 8=E 9=F 10=G

11=# 12=H 13=K 14=L 15=Z 16=T 17=O 18=P

19=% 20=Q 21=R 22=S 23=N 24=U 25=V 26=W

27=X 28=Y 29=M 30=&

THE ANSWER OF THE QUESTION IS THE REMAIDER OF THE RESULT OF THE MATHEMATIC EXPRESSION DIVIDED BY 31.

The players must input the answer (“selected answer” or “input answer”) within a time limit (e.g., 5 seconds) set by a timer (not shown) (S12). The mathematic expression is so set that the answer could not be calculated by one skilled in arithmetic calculation within the time limit. After the input procedure (“wagering procedure”) via the input unit 1, the operational unit 3 carries out calculation of the mathematic expression to obtain the result (correct answer), and the correct answer is displayed on the output unit 4 or the display unit 2 (S14). Of course, the calculating operation can be carried out before the end of the input procedure and displayed immediately after the wagering procedure. Wagering by the players after ending of the time limit is not allowed and/or canceled. The input answer is compared with the correct answer (S16), and the result is displayed on the display unit 2 and/or the output unit 4 (S18).

In another example, the question may be as follows:

COMPARE THE RESULT OF THE FOLLOWING MATHEMATIC EXPRESSION WITH 7:

It is noted that any questions can be used.

Further, any other mathematic signs can also be used, such as log, exponential, radial, etc.

Thus, the prevent invention provides a method for playing a game as follows:

displaying a mathematic expression including a plurality of parameters and values of the parameters on a display unit;

inputting selected answer of the mathematic expression by at least one player; and

displaying a correct answer of the mathematic expression.

Since the question and the mathematic expression are displayed before the wagering procedure and the correct answer is displayed thereafter, a fair game is provided. Further, the mathematic expression provides an additional amusement effect in a way.

Although specific embodiments have been illustrated and described, numerous modifications and variations are still possible without departing from the essence of the invention. The scope of the invention is limited by the accompanying claims.

What is claimed is:

1. An electric apparatus for a game, comprising:
a display unit for displaying a mathematic expression including a plurality of parameters, the displaying unit also displaying corresponding values of the parameters;
an operational unit for calculating a correct answer of the mathematic expression, the operational unit including a memory for storing programs relating to the mathematic expression; and
an input unit allowing at least one player to input selected answer of the mathematic expression;
the mathematic expression being displayed on the display unit before input of the selected answer;
the correct answer of the mathematic expression being displayed after input of the selected answer.

2. The electric apparatus as claimed in claim 1 wherein the input unit comprises at least one set of buttons.

3. The electric apparatus as claimed in claim 1 wherein the display unit is a monitor.

4. The electric apparatus as claimed in claim 1 wherein the operational unit is a computer host.

5. The electric apparatus as claimed in claim 1 wherein the memory is a chip that stores programs and information relating to the mathematic expression.

6. The electric apparatus as claimed in claim 1 further comprising an output unit for displaying the correct answer of the mathematic expression.

7. The electric apparatus as claimed in claim 1 wherein the correct answer of the mathematic expression is displayed by the display unit.

8. The electric apparatus as claimed in claimed 1 wherein the operational unit compares the selected answer with the corrected answer.

9. The electric apparatus as claimed in claim 1 wherein the mathematic expression includes at least one mathematic sign.

10. A method for playing a game, comprising the steps of:
displaying a mathematic expression including a plurality of parameters and values of the parameters on a display unit;
inputting selected answer of the mathematic expression by at least one player; and
displaying a correct answer of the mathematic expression.

11. The method as claimed in claim 10 wherein the step of displaying including displaying a question relating to the mathematic expression.

12. The method as claimed in claim 10 further comprising a step of comparing the selected answer with the correct answer.

13. The method as claimed in claim 1 wherein the mathematic expression includes at least one mathematic sign.
